(19) United States
(12) Patent Application Publication
(10) Pub. No.: US 2014/0334091 A1
(43) Pub. Date: Nov. 13, 2014

(54) COUNTER ROTATING BLOWER WITH INDIVIDUAL CONTROLLABLE FAN SPEEDS

(71) Applicant: NVIDIA Corporation, Santa Clara, CA (US)

(72) Inventors: Srinivasa R. DAMARAJU, San Jose, CA (US); Joseph D. WALTERS, Campbell, CA (US); Dalton Seth O'CONNOR, Santa Clara, CA (US)

(21) Appl. No.: 13/889,172

(22) Filed: May 7, 2013

(51) Int. Cl. F04D 27/00; G06F 1/20; F04D 17/00

(52) U.S. Cl. CPC F04D 27/004; F04D 17/00; G06F 1/20
USPC 361/679.47; 454/258; 416/128; 416/37

(57) ABSTRACT

A blower having counter rotating fan blades for generating uniform air flow across a heat sink, which maximizes the cooling efficiency of the heat sink. The counter rotating fan blades may individually controlled to optimize performance of the blower. Only one set of fan blades may be used for low temperature conditions, thereby consuming less power and reducing acoustic noise, while both sets of fan blades may be used for high temperature conditions, thereby maximizing heat transfer. The blower may be configured to operate one or both sets of fan blades at a desired operating fan speed based on one or more pre-determined conditions. The pre-determined conditions include at least one of temperature, acoustic, and power levels and or measurements of one or more components of the computer system.

### BACKGROUND OF THE INVENTION

1. Field of the Invention

Embodiments of the invention generally relate to cooling devices for computer systems, and more specifically, to a counter rotating blower with individual controllable fan speeds.

2. Description of the Related Art

Electronic devices generally include a printed circuit board (PCB) with external and internal wiring for transferring signals between integrated circuits (and other electronic components) that are mechanically supported by and electrically connected to the PCB. As integrated circuit technology improves, more functionality can be built into smaller and smaller packages. An increased number of integrated circuits can be mounted on a PCB, thereby improving the performance of a common electronic device, a computer graphics card being just one example.

These improved integrated circuits, however, generate more heat while possessing smaller surface areas to dissipate the heat. It is important to have a high rate of heat transfer from the electronic device to maintain the temperatures of the integrated circuits within safe operating limits. Excessive temperatures may cause permanent degradation of the integrated circuits and thereby affect the performance of the electronic device.

A heat sink may be mounted on or adjacent to the surfaces of the integrated circuits to cool the electronic device. The heat sink is generally formed from a metallic material having a high rate of thermal conductivity to conduct heat away from the integrated circuits and dissipate heat to the surrounding air. In addition, a fan may be used to blow air across the heat sink to convectively draw heat from the heat sink for an overall increase in heat transfer from the integrated circuits.

Prior art configurations of heat sinks and fans have several drawbacks. One drawback is that current fan designs are not capable of directing a uniform air flow across the heat sink. This un-equal distribution of air flow causes one portion of the heat sink to cool better than another portion, thereby impairing the overall efficiency of the heat sink. Another drawback is that current fan designs are configured to continuously blow air at a high fixed speed, which uncontrollably increases acoustic noise and ineffectively consumes power in situations when less or even no air flow is required.

Accordingly, what is needed in the art is a more effective approach for handling heat transfer issues in electronic devices.

### SUMMARY OF THE INVENTION

Embodiments of the invention include a blower for directing air flow across a heat sink. The blower comprises a first set of fan blades, a second set of fan blades, and a support plate disposed between the first set of fan blades and the second sets of fan blades. The first set of fan blades and the second sets of fan blades are simultaneously rotatable in opposite directions to direct air flow across the heat sink.

Embodiments of the invention include a cooling device for a computer system. The cooling device comprises a heat sink for cooling a component of the computer system, and a blower for directing air flow across the heat sink. The blower comprises a first set of fan blades, a second set of fan blades, and a support plate disposed between the first set of fan blades and the second set of fan blades. The first set of fan blades and the second set of fan blades are simultaneously rotatable in opposite directions to direct air flow across the heat sink.

Embodiments of the invention include a method of operating a blower for directing air flow across a heat sink. The method comprises causing a first set of fan blades of the blower to rotate in a first direction, simultaneously causing a second set of fan blades of the blower to rotate in a second, counter rotating direction to direct air flow across the heat sink, and causing a fan speed of the first set of fan blades and the second set of fan blades to be adjusted based on at least one of a temperature level measurement, an acoustic level measurement, and a power usage measurement.

One advantage of the embodiments of the invention is generating a uniform distribution of air flow across a heat sink, which maximizes the cooling efficiency of the heat sink.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the invention.

FIG. 2 is a perspective view of an add-in card having a housing and a circuit board for supporting a blower and a heat sink, according to one embodiment of the present invention.

FIG. 3 is another perspective view of the add-in card with the housing removed, illustrating the blower and the heat sink of FIG. 2, according to one embodiment of the present invention.

FIG. 4 is a top plan view of the add-in card with the housing removed, illustrating the blower and the heat sink of FIG. 2, according to one embodiment of the present invention.

FIG. 5 is a right side view of the add-in card with the housing removed, illustrating the blower and the heat sink of FIG. 2, according to one embodiment of the present invention.

FIG. 6 is a left side view of the add-in card with the housing removed, illustrating the blower and the heat sink of FIG. 2, according to one embodiment of the present invention.

FIG. 7 is a front view of the add-in card with the housing removed, illustrating the blower and the heat sink of FIG. 2, according to one embodiment of the present invention.

FIG. 8 is a bottom plan view of the add-in card with the housing removed, illustrating a portion of the blower of FIG. 2, according to one embodiment of the present invention.

FIG. 9 is a flow diagram of method steps for operating the blower of FIG. 2, according to one embodiment of the present invention.

### DETAILED DESCRIPTION

In the following description, numerous specific details are set forth to provide a more thorough understanding of the embodiments of the invention. However, it will be apparent to one of skill in the art that the invention may be practiced without one or more of these specific details.

### Computer System Overview

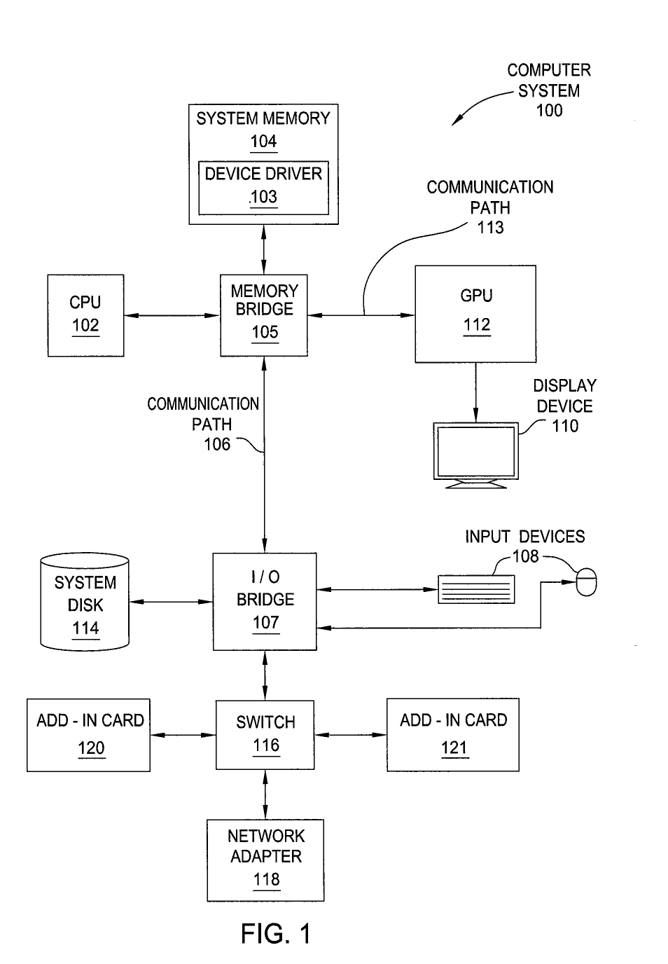

FIG. 1 is a block diagram illustrating a computer system 100 configured to implement one or more aspects of the invention. As shown, the computer system 100 includes, without limitation, a central processing unit (CPU) 102 and a system memory 104 that includes a device driver 103, all communicating via an interconnection path that may include a memory bridge 105. The memory bridge 105, which may be, e.g., a Northbridge chip, is connected via a bus or other communication path 106 (e.g., a HyperTransport link) to an I/O (input/output) bridge 107. The I/O bridge 107, which may be, e.g., a Southbridge chip, receives user input from one or more user input devices 108 (e.g., keyboard, mouse) and forwards the input to the CPU 102 via the communication path 106 and the memory bridge 105. A graphics processing unit (GPU) 112 is coupled to the memory bridge 105 via a bus or second communication path 113 (e.g., a Peripheral Component Interconnect (PCI) Express, Accelerated Graphics Port, or HyperTransport link). In one embodiment, a parallel processing subsystem having one or more GPUs 112 may be included in the computer system 100. The GPU 112 or the parallel processing subsystem having multiple GPUs 112 delivers pixels to a display device 110 that may be any conventional cathode ray tube, liquid crystal display, light-emitting diode display, or the like. A system disk 114 is also connected to the I/O bridge 107 and may be configured to store content and applications and data for use by the CPU 102 and the GPU 112. The system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between the I/O bridge 107 and other components such as a network adapter 118 and various add in cards 120 and 121. Other components, including universal serial bus (USB) or other port connections, compact disc (CD) drives, digital versatile disc (DVD) drives, film recording devices, and the like, may also be connected to the I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point to point communication protocol(s). Connections between different devices may also use different protocols as is known in the art.

In one embodiment, the GPU 112 or the parallel processing subsystem having multiple GPUs 112 incorporates circuitry optimized for graphics and video processing, including, for example, video output circuitry. In another embodiment, the GPU 112 or the parallel processing subsystem having multiple GPUs 112 incorporates circuitry optimized for general purpose processing, while preserving the underlying computational architecture, described in greater detail herein. In yet another embodiment, the GPU 112 or the parallel processing subsystem having multiple GPUs 112 may be integrated with one or more other system elements in a single subsystem, such as joining the memory bridge 105, the CPU 102, and the I/O. bridge 107 to form a system on chip (SoC).

It will be appreciated that the system shown herein is illustrative and that variations and modifications are possible. The connection topology, including the number and arrangement of bridges, the number of CPUs 102, and the number of GPUs 112, may be modified as desired. For instance, in some embodiments, the system memory 104 is connected to the CPU 102 directly rather than through a bridge, and other devices communicate with the system memory 104 via the memory bridge 105 and the CPU 102. In other alternative topologies, GPU 112 is connected to the I/O bridge 107 or directly to the CPU 102, rather than to the memory bridge 105. In still other embodiments, the I/O bridge 107 and the memory bridge 105 might be integrated into a single chip instead of existing as one or more discrete devices. Large embodiments may include two or more CPUs 102 and two or more CPUs 112. The particular components shown herein are optional; for instance, any number of add in cards or peripheral devices might be supported. In some embodiments, the switch 116 is eliminated, and the network adapter 118 and the add in cards 120, 121 connect directly to the I/O bridge 107.

Persons of ordinary skill in the art will understand that the architecture described in FIG. 1 in no way limits the scope of the invention and that the techniques taught herein may be implemented on any properly configured computer system, including, without limitation, one or more CPUs, one or more multi-core CPUs, one or more GPUs 112, and one or more parallel processing subsystems having multiple GPUs or special purpose processing units, or the like, without departing the scope of the invention.

### Blower with Counter Rotating Fan Blades

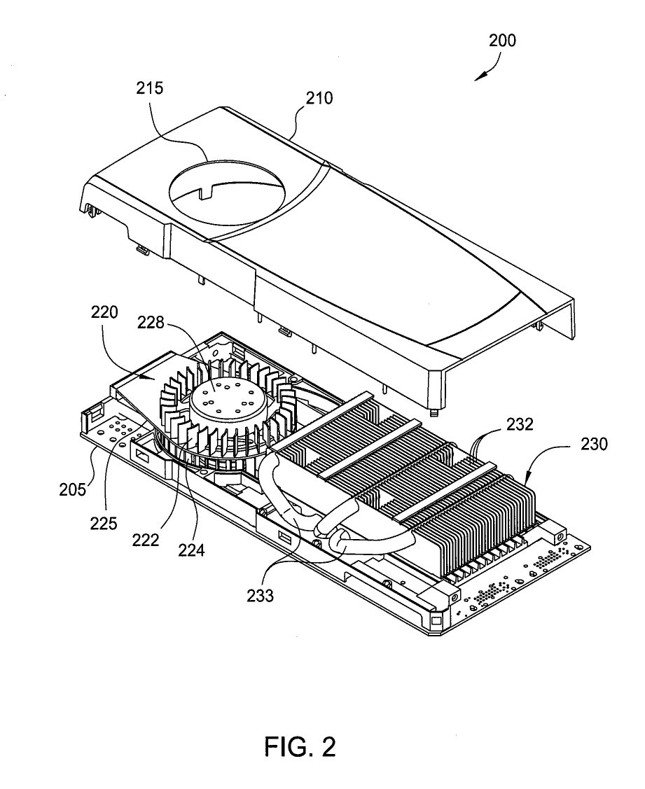

FIG. 2 is a perspective view of an add-in card 200 (such as add-in cards 120, 121 shown in FIG. 1) for use with the computer system 100, according to one embodiment of the present invention. As shown, the add-in card 200 may include a circuit board 205 for supporting a plurality of components, including a blower 220 and a heat sink 230. The add-in card 200 may also include a housing 210 removably coupled to the circuit board 205 for enclosing and thereby structurally protecting the internal components. The housing 210 may include an opening 215 that is positioned above the blower 220 for allowing air from the surrounding environment to be drawn into the housing 210 and circulated across the heat sink 230 by the blower 220. The circuit board 205 may include an opening 212 (illustrated in FIG. 8) that is positioned below the blower 220 for allowing air from the surrounding environment to be drawn into the housing 210 and circulated across the heat sink 230 by the blower 220. Although illustrated and described herein as being part of an add-in card, the embodiments of the invention are not limited to use with add-in cards, but may be used with other types and arrangements of circuit boards, electronic components and devices, and/or computer systems.

The heat sink 230 may include any type or arrangement of heat exchange systems known in the art for conducting heat away from and thereby cooling one or more components supported by the circuit board 205. The heat sink 230 may be directly or indirectly coupled to, and/or positioned adjacent to, one or more components to be cooled. Examples of components that can be supported by the circuit board 205 and cooled by the heat sink 230 may include, but are not limited to, CPUs (such as CPU 102), CPUs (such as GPU 112), and other integrated type circuits.

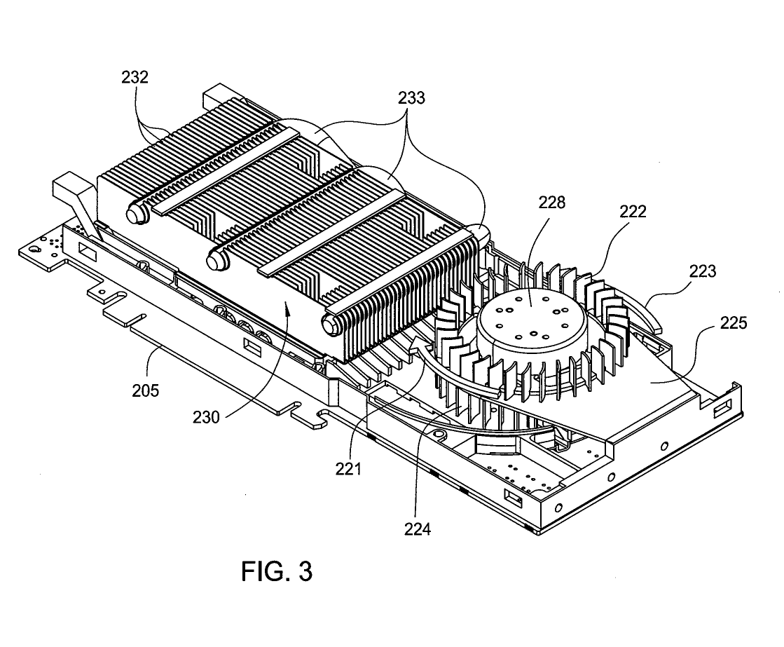

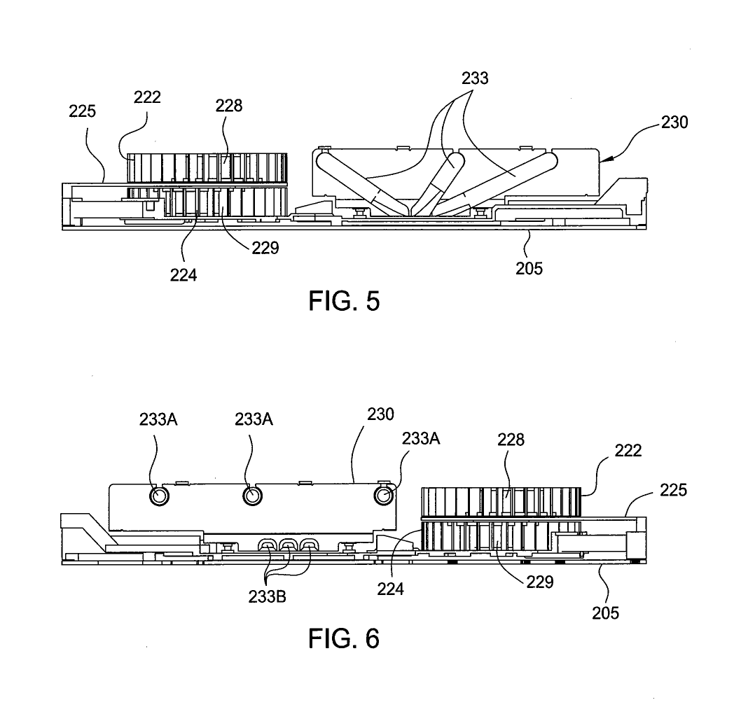

Referring to FIGS. 2 and 3, the heat sink 230 may be formed from a material (such as aluminum, copper, and other similar types of metallic materials) for effectively conducting heat away from one or more components supported by the circuit board 20 and for dissipating the heat into the surrounding air. The heat sink 230 may include a plurality of closely spaced fins 232 (e.g. pin, straight, flared shaped fins) arranged to increase the surface area in contact with the air blown across the heat sink 230 by the blower 220 to remove heat and maximize cooling efficiency. The heat sink 230 may also include a plurality of conduits 233 disposed through a lower portion of the heat sink 230 closest to the component(s) to be cooled, and extending across an upper portion of the heat sink 230 to draw heat from the lower portion and distribute the heat across the fins 232 to further maximize cooling efficiency. The upper ends 233A and the lower ends 233B of the conduits 233 are illustrated in FIG. 6, while the bend portions of the conduits 233 disposed between the upper ends 233A and the lower ends 233B are illustrated in FIG. 5. Numerous other heat sink types, shapes, and arrangements known in the art may be used with the embodiments described herein.

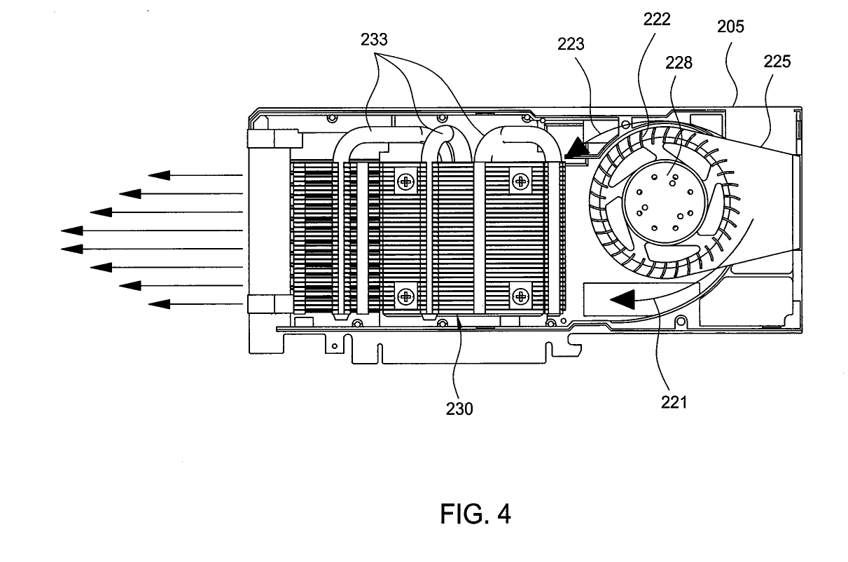

Referring to FIGS. 3 and 4, the blower 220 may include a counter rotating fan blade arrangement operable to provide a uniform air flow distribution across the fins 232 and the conduits 233 of the heat sink 230 to maximize cooling efficiency. The counter rotation of the fan blades as further described herein generates the uniform air flow across the head sink 230. The counter rotating fan blade arrangement may include individually controllable fan blades and adjustable fan blade speeds for optimizing power consumption and performance of the blower 220. The blower 220 is designed to overcome the deficiencies of prior blower designs that cannot generate uniform air flow distribution across heat sinks and/or cannot optimize power consumption, thereby resulting in less heat sink efficiency and less overall performance.

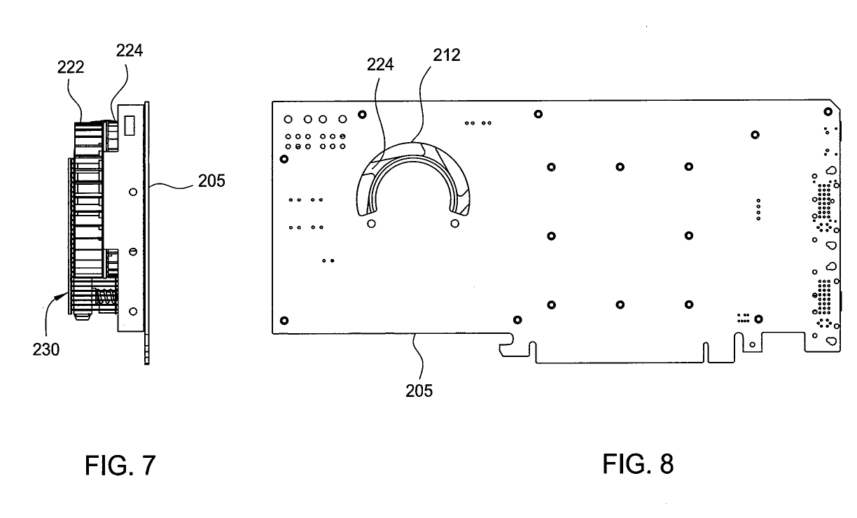

As illustrated in FIGS. 2-8, the blower 220 may be coupled to the circuit board 205 adjacent to the heat sink 230. The blower 220 may include a first set of fan blades 222 and a second set of fan blades 224 separated by a support plate 225 that is coupled to the circuit board 205. The first set of fan blades 222 may be connected to a central hub 228 for rotating the fan blades 222. The second set of fan blades 224 may be similarly connected to a central hub 229 illustrated in FIGS. 5 and 6. The central hubs 228, 229 may be coupled to the support plate 225 and/or the circuit board 205. The blower 220 may include one or more motors, power supplies, shafts, belts, pulleys, gears, bearings, etc., as known in the art for providing rotation to the first and second sets fan blades 222, 224.

The first set of fan blades 222 may be disposed on top of the support plate 225 above the second set of fan blades 224. The first set of fan blades 222 may be oriented and rotatable in a first direction, such as a clockwise direction as indicated by reference arrow 221 (illustrated in FIGS. 3 and 4). The second set of fan blades 224 may be oriented and rotatable in a second, opposite direction, such as a counterclockwise direction as indicated by reference arrow 223 (illustrated in FIGS. 3 and 4). Each set of fan blades 222, 224 may be individually controlled to rotate at the same or different operating speeds. Either of the sets of fan blades 222, 224 may be adjusted to and operated at a specific fan speed based on one or more per-determined conditions, including but not limited to temperature, acoustic, and power usage levels or measurements of one or more components of the add-in card 200 and/or the computer system 100.

The blower 220 may be controlled by a control unit, such as the CPU 112 and/or another similar processing unit that is a part of the computer system 100, another computer system, and/or integrated into the circuit board 205 of the add-in card 200. The control unit may be a programmable logic controller with memory, mass storage devices, power supplies, clocks, cache, input/output circuits, and/or other components know in the art. The control unit may monitor and adjust the operating speeds of the first and second sets of fan blades 222, 224 based on one or more pre-determined conditions, including but not limited to temperature, acoustic, and power usage levels or measurements of one or more components of the add-in card 200 and/or the computer system 100. The control unit may monitor and/or receive signals corresponding to temperature, acoustic, and power usage levels or measurements of one or more components of the add-in card 200 and/or the computer system 100.

For one example, the control unit may be programmed to operate the first and second sets of fan blades 222, 224 at maximum fan speeds when the measured temperature of one or more components of the add-in card 200 and/or the computer system reaches or rises above a pre-determined temperature. For another example, the control unit may be programmed to operate the first and second sets of fan blades 222, 224 at minimum fan speeds (or fan speeds less than maximum fan speed) when the measured temperature of one or more components of the add-in card 200 and/or the computer system reaches or falls below a pre-determined temperature. For a further example, the control unit may be programmed to operate only one of the first and second sets of fan blades 222, 224 when the measured acoustic level or power usage of one or more components of the add-in card 200 and/or the computer system reaches or rises above a per-determined amount.

The operating speeds of the first and second sets of fan blades 222, 224 also may be adjusted by a user via the control unit. The user may select a desired fan operating speed (e.g. maximum fan speed, minimum fan speed, or any fan speed between maximum and minimum fan speed) of one or both of the sets of fan blades 222, 224, which selection may be communicated to the control unit to operate the blower 20 at the desired fan speed. The user may change or adjust the fan operating speeds as desired or based on temperature, acoustic, and power usage levels or measurements of one or more components of the add-in card 200 and/or the computer system 100.

During one operation of the blower 220, the first set of fan blades 222 and the second set of fan blades 224 may be rotated simultaneously in opposite (counter rotating) directions but at the same operating speeds to substantially distribute air flow uniformly across the surfaces of the fins 232 and the conduits 233 of the heat sink 230. The uniform distribution of air flow generated by the blower 220 maximizes the cooling efficiency of the heat sink 230 by removing heat uniformly from all of the surfaces of the heat sink 230. A non-uniform distribution of air flow across the heat sink 230 may result in one portion of the heat sink 230 dissipating heat at a greater rate than another portion of the heat sink 230. The operating speeds of the first and second sets of fan blades 222, 224 may be adjusted to achieve a desired heat dissipation rate via the heat sink 230.

The first and second sets of fan blades 222, 224 may be rotated at a maximum fan speed to maximize the amount of heat dissipated from the heat sink 230. Alternatively, the first and second sets of fan blades 222, 224 may be rotated at a minimum fan speed or any other fan speed that is less than the maximum fan speed. Alternatively still, the first set of fan blades 222 may be rotated at a maximum fan speed, while the second set of fan blades 224 are rotated at a minimum fan speed or any other fan speed that is less than the maximum fan speed, and vice versa. The fan speed of one or both of the sets of fan blades 222, 224 may be adjusted between the minimum and maximum fan speeds. Lowering of the fan speed of either of the sets of fan blades 222, 224 from the maximum fan speed may reduce the amount of noise generated and power consumed by the blower 220.

During another operation of the blower 220, where less heat dissipation is needed for example, only one of the sets of fan blades 222, 224 may be operated while the other set of fan blades 222, 224 remains idle or non-rotating. In this instance, the blower 220 may be configured to minimize noise (acoustic) and/or power consumption. Operating only one of the sets of fan blades 222, 224 may generate less noise and consume less power than when operating both of the sets of fan blades 222, 224.

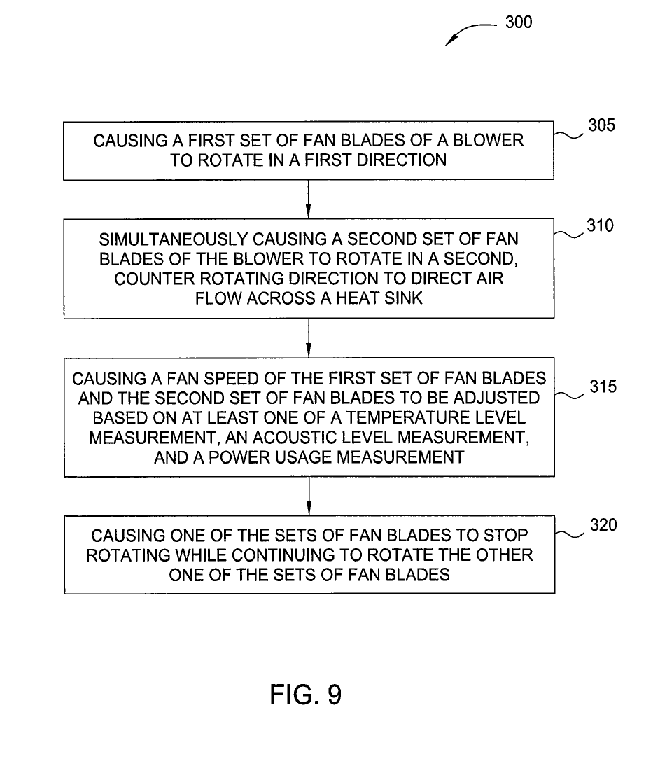

FIG. 9 is a flow diagram of method steps for operating the blower 220 to direct air flow across the heat sink 230, according to one embodiment of the invention. Although the method steps are described in conjunction with the systems of FIGS. 1-8, persons skilled in the art will understand that any system configured to implement the method steps, in any order, falls within the scope of the invention.

As shown, a method 300 includes an initial step 305 of causing the first set of fan blades 222 to rotate in a first direction. At step 310, the second set of fan blades 224 may be simultaneously caused to rotate in a second, counter rotating direction to direct air flow across the heat sink 230. The simultaneously rotating first and second sets of fan blades 222, 224 may be rotated at a first fan speed. The first fan speed may be the minimum or maximum operating speed that the fan blades 222, 224 may be rotated. At step 315, when desired by a user or upon receiving a signal corresponding to a pre-determined condition, the method may include causing the fan speed of the first and second sets of fan blades 222, 224 to be adjusted based on at least one of a temperature level measurement, an acoustic level measurement, and a power usage measurement. The pre-determined condition may be monitored by a user and/or the control unit. The fan speed of the first and/or second set of fan blades 222, 224 may be adjusted to a second fan speed that is different (greater or less) than the first fan speed, via the control unit. Subsequent to, or as an alternative to step 315, at step 320, when desired by a user or upon receiving a signal corresponding to a pre-determined condition, the method may include causing one of the sets of fan blades 222, 224 to stop rotating while continuing to rotate the other one of the sets of fan blades 222, 224, via the control unit. The pre-determined condition may be a temperature, acoustic, and/or power usage level or measurement of one or more components of the add-in card 200 and/or the computer system 100.

In sum, embodiments of the invention include a blower having individually controllable, counter rotating sets of fan blades for generating a uniform distribution of air flow across a heat sink. Each set of the counter rotating fan blades may be individually controlled by a control unit. The blower may be operated, and in particular the fan blade operating speed may be adjusted, using one or both sets of fan blades based on one or more pre-determined conditions. The pre-determined conditions may include at least one of temperature, acoustic, and power levels and/or measurements of one or more components of the computer system.

The counter rotating sets of fan blades provide the advantage of generating a uniform distribution of air flow across the heat sink, which maximizes the cooling efficiency of the heat sink. An unequal distribution of air flow, as generated by prior blower designs, results in one portion of the heat sink dissipating heat at a greater rate than another portion of the heat sink, thereby inhibiting efficient use of the heat sink. An additional advantage of the blower is that the counter rotating sets of fan blades may be individually controlled to optimize performance of the blower. In particular, only one set of fan blades may be used for low temperature conditions, thereby consuming less power and reducing acoustic noise, while both sets of fan blades may be used for high temperature conditions, thereby maximizing heat transfer.

While the foregoing is directed to embodiments of the invention, other and further embodiments of the invention may be devised without departing from the basic scope thereof, and the scope thereof is determined by the claims that follow.

1. A blower for directing air flow across a heat sink, comprising:
a first set of fan blades;
a second set of fan blades; and
a support plate disposed between the first set of fan blades and the second set of fan blades, wherein the first set of fan blades and the second set of fan blades are simultaneously rotatable in opposite directions to direct air flow across the heat sink.

2. The blower of claim 1, wherein the first set of fan blades is coupled to a first central hub that is disposed above the support plate.

3. The blower of claim 2, wherein the second set of fan blades is coupled to a second central hub that is disposed below the support plate.

4. The blower of claim 3, wherein the first set of fan blades is rotatable in a clockwise direction, and wherein the second set of fan blades is rotatable in a counterclockwise direction.

5. The blower of claim 1, further comprising a control unit configured to adjust the operating speed of the first set of fan blades and to adjust the operating speed of the second set of fan blades.

6. The blower of claim 5, wherein the control unit is configured to adjust the operating speed of the first set of fan blades and to adjust the operating speed of the second set of fan blades based on at least one of a temperature level measurement, an acoustic level measurement, and a power usage measurement.

7. The blower of claim 1, further comprising a control unit configured to cause only one set of the first set of fan blades and the second set of fan blades to rotate while the other set is idle or not rotating.

8. A cooling device for a computer system, comprising:
a heat sink for cooling a component of the computer system; and
a blower for directing air flow across the heat sink, wherein the blower comprises:
a first set of fan blades;
a second set of fan blades; and
a support plate disposed between the first set of fan blades and the second set of fan blades, wherein the first set of fan blades and the second set of fan blades are simultaneously rotatable in opposite directions to direct air flow across the heat sink.

9. The device of claim 8, further comprising a circuit board for supporting the heat sink, the blower, and the component of the computer system cooled by the heat sink.

10. The device of claim 9, further comprising a housing coupled to the circuit board and enclosing the heat sink, the blower, and the component of the computer system cooled by the heat sink.

11. The device of claim 10, wherein the housing comprises an opening disposed adjacent to the first set of fan blades for allowing air from the surrounding environment to be drawn into the housing and circulated across the heat sink by the blower.

12. The device of claim 11, wherein the circuit board comprises an opening disposed adjacent to the second set of fan blades for allowing air from the surrounding environment to be drawn into the housing and circulated across the heat sink by the blower.

13. The device of claim 8, wherein the first set of fan blades is coupled to a first central hub that is disposed above the support plate.

14. The device of claim 13, wherein the second set of fan blades is coupled to a second central hub that is disposed below the support plate.

15. The device of claim 14, wherein the first set of fan blades are rotatable in a clockwise direction, and wherein the second set of fan blades are rotatable in a counterclockwise direction.

16. The device of claim 8, further comprising a control unit configured to adjust the operating speed of the first set of fan blades and to adjust the operating speed of the second set of fan blades.

17. The device of claim 16, wherein the control unit is configured to adjust the operating speed of the first set of fan blades and to adjust the operating speed of the second set of fan blades based on at least one of a temperature level measurement, an acoustic level measurement, and a power usage measurement.

18. The device of claim 8, further comprising a control unit configured to cause only one set of the first set of fan blades and the second set of fan blades to rotate while the other set is idle or not rotating.

19. A method of operating a blower for directing air flow across a heat sink, comprising:
causing a first set of fan blades of the blower to rotate in a first direction;
simultaneously causing a second set of fan blades of the blower to rotate in a second, counter rotating direction to direct air flow across the heat sink; and
causing a fan speed of the first set of fan blades and the second set of fan blades to be adjusted based on at least one of a temperature level measurement, an acoustic level measurement, and a power usage measurement.

20. The method of claim 19, further comprising causing one of the sets of fan blades to stop rotating while continuing to rotate the other one of the sets of fan blades.
